(19) United States
(12) Patent Application Publication
(10) Pub. No.: US 2006/0050307 A1
(43) Pub. Date: Mar. 9, 2006

(54) Image forming apparatus, job processing method, computer program, storage medium, and image forming system

(76) Inventor: Hiroaki Koike, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/219,490

(22) Filed: Sep. 2, 2005

(30) Foreign Application Priority Data
Sep. 3, 2004 (JP) 2004-257419

(51) Int. Cl. G06F 3/12

(52) U.S. Cl. 358/1.15

(57) ABSTRACT

This invention provides an image forming apparatus, job processing method, and the like, which consider the needs, operability, and use environments of the operator in the print system. To this end, an image forming apparatus, which can print job data in storage unit that can store a plurality of independent job data, has control unit adapted to control the image forming apparatus to execute a multiple job continuous print operation for continuously executing print processing of a plurality of independent job data of the job data in the storage unit, and the control unit controls the image forming apparatus to execute test print processing of each of the plurality of job data to be continuously printed to allow a user to confirm a print result before completion of all print processes of the plurality of job data to be continuously printed by the multiple job continuous print operation.

### FIELD OF THE INVENTION

The present invention relates to an image forming apparatus which can receive a plurality of job data, a job processing method, a computer program, a storage medium, an image forming system, and the like.

### BACKGROUND OF THE INVENTION

Conventionally, commercial print services that alternatively perform generation of a print product according to a request from a client are available. Such commercial print services receive print data as an original and instructions such as print style, number of copies, due date, and the like from the client. They then generate print products based on the instructions and deliver the generated print products to the customer.

In recent years, in such commercial print services, POD (Print On Demand) has received a lot of attention. POD is a digital print technique for printing digital data created by, e.g., a computer using a digital multi-function peripheral or the like without the intervention of any prepress operations. POD has an advantage of, e.g., obtaining a final product within a shorter period of time than conventional offset printing. In copy shops scattered across towns and in commercial print services for central and local government offices, universities, and the like, use of POD has been examined. Note that Japanese Patent Laid-Open No. 2003-122538 is available as a reference associated with POD.

In a print system using POD, an image forming apparatus (digital multi-function peripheral, printer, or the like), system, or the like, which is convenient for an operator, is required.

In the print system using POD, an operator of the print agent processes data from a client by operating an image forming apparatus. For example, in view of total cost ownership (to be referred to as TCO hereinafter), it is important to utilize the image forming apparatus as much as possible and to minimize idle hours while the image forming apparatus is operative. For this purpose, a situation in which it is desirable to utilize the image forming apparatus as much as possible even during a period in which the operator is not near the image forming apparatus is assumed. In such situations, it is expected that the operator wants to continuously execute print processing of a plurality of independent print job data received from a client in large quantities using the image forming apparatus even when he or she is not near the image forming apparatus. On the other hand, it is expected that the operator of the image forming apparatus wants to confirm the finished state of the print result of print job data to be processed.

However, in the present circumstances, such confirmation operation of the print result can only be done after all the print processes of a plurality of job data are completed. Hence, if print job data is printed under a printing condition different from a desired finished state due to setting errors of the operator and/or errors in the data itself, the print processing of the print job data must be redone from the beginning. As a result, resources (expendables such as printing paper sheets, toner, staples, and the like) are wasted, and the operator himself or herself experiences extra trouble, thus producing wasteful labor costs.

### SUMMARY OF THE INVENTION

The present invention has been made in consideration of the above problems, and has as its object to provide an image forming apparatus, job processing method, and the like, which take the operator's needs, operability, and use environment in the print system into consideration.

In order to achieve the above object, for example, an image forming apparatus according to the present invention comprises the following arrangement. That is, there is provided an image forming apparatus which can print job data from a storage unit that can store a plurality of independent job data, comprising:

control unit adapted to control the image forming apparatus to execute a multiple job continuous print operation for continuously executing print processing of a plurality of independent job data of the job data in the storage unit, and

in that the control unit controls the image forming apparatus to execute test print processing of each of the plurality of job data to be continuously printed to allow a user to confirm a print result before completion of all print processes of the plurality of job data to be continuously printed by the multiple job continuous print operation.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the arrangement of an image forming apparatus according to an embodiment of the present invention;

FIG. 2 is a block diagram showing the arrangement of an image forming system according to the embodiment of the present invention;

FIG. 3 illustrates the recording state of print job data and printing condition information in an HDD 2004 of a multi-function peripheral 202 according to the embodiment of the present invention;

FIG. 4 is a flowchart showing the flow of the overall processing of the MFP according to the embodiment of the present invention;

FIG. 5 is a flowchart showing the flow of processing in the “1. print mode designation” step according to the embodiment of the present invention;

FIG. 6 shows an example of a basic screen according to the embodiment of the present invention;

FIG. 7 shows a display example of a list of print job data according to the embodiment of the present invention;

FIG. 8 is a flowchart showing the flow of processing in the “2. selected print job data confirmation” step in a “date-designated continuous printing” mode according to the embodiment of the present invention;

FIG. 9 shows an example of a date-designated continuous printing setting screen in the “date-designated continuous printing” mode according to the embodiment of the present invention;

FIG. 10 is a flowchart showing the flow of processing in the “3. print setting” step in the “date-designated continuous printing” mode according to the embodiment of the present invention;

FIG. 11 shows an example of a test print setting screen according to the embodiment of the present invention;

FIG. 12 shows an example of a screen used to change print settings according to the embodiment of the present invention;

FIG. 13 shows an example of a screen used to confirm print job data and print setting contents according to the embodiment of the present invention;

FIG. 14 is a flowchart showing the flow of processing in the “4. print start” step in the “date-designated continuous printing” mode according to the embodiment of the present invention;

FIG. 15 is a flowchart showing the flow of processing in the “2. selected print job data confirmation” step in a “continuous printing” mode according to the embodiment of the present invention;

FIG. 16 shows an example of a continuous printing setting screen in the “continuous printing” mode according to the embodiment of the present invention; and

FIG. 17 is a flowchart showing the flow of processing of the “3. print setting/printing” step according to the embodiment of the present invention.

### DETAILED DESCRIPTION OF THE PREFERRED EMBODIMENTS

Preferred embodiments according to the present invention will be described in detail hereinafter with reference to the accompanying drawings. Note that building components described in the embodiments are merely examples, and the scope of the present invention is not limited to those.

[Arrangement of Image Forming Apparatus]

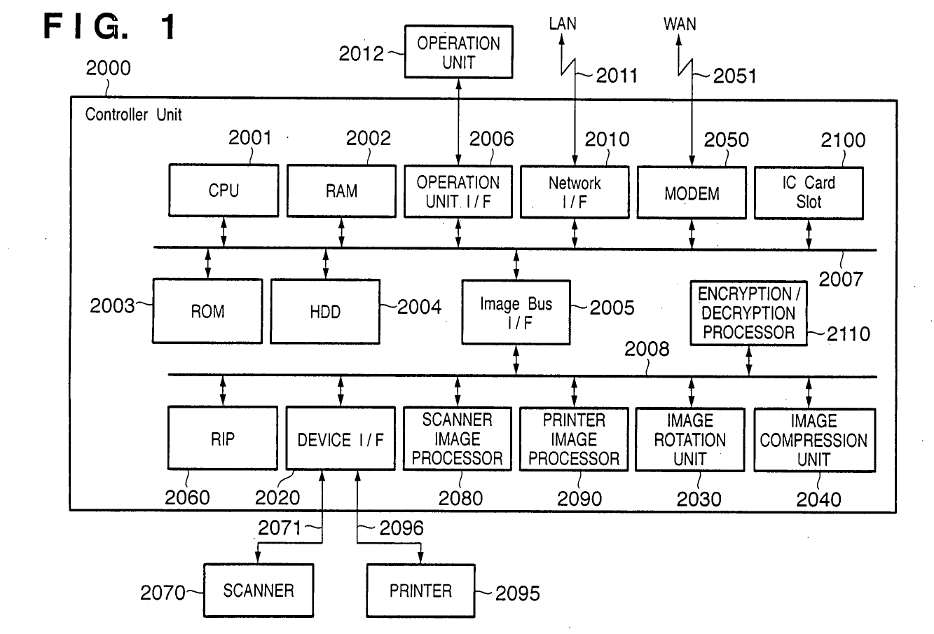

FIG. 1 is a block diagram showing the arrangement of an image forming apparatus (MFP 202) according to this embodiment. In this embodiment, the following explanation will be given taking as an example an image forming apparatus, which is a digital MFP having a plurality of functions including at least any of: a copy function which allows a printer unit of the self apparatus to execute a print process of print job data (to be also referred to as a job, print job, job data, image data, and document data) input from a scanner unit of the self apparatus via a memory unit of the self apparatus such as a hard disk or the like which can store a plurality of print job data; a print function which allows the printer unit of the self apparatus to execute a print process of print job data output from a host computer and/or another image forming apparatus via the memory unit; a transmission function which can transmit print job data stored in a memory of the self apparatus to a host computer or another image forming apparatus; and the like.

Note that an explanation of this embodiment will be given mainly using a multi-function type image forming apparatus having a plurality of functions such as a copy function, print function, and the like (multi-function peripheral: to be also referred to as MFP hereinafter). However, for example, a single-function type image forming apparatus having only a print function (single-function peripheral: to be also referred to as SFP hereinafter) may be used. Also, an explanation of this embodiment will be given mainly using an integrated type apparatus which incorporates all of a plurality of units such as a scanner unit, memory unit, printer unit, and the like. However, these units may form independent, separate devices.

As shown in FIG. 1, the image forming apparatus includes a controller unit 2000 which controls the overall apparatus, and makes control associated with input/output of image data and device information, an operation unit 2012 having a function of a user interface, a scanner 2070 as an image input device, and a printer 2095 as an image output device. Also, a LAN (Ethernet® or the like) 2011 and public line (to be referred to as a WAN hereinafter) 2051 are connected to the image forming apparatus. With this arrangement, the image forming apparatus has a copy function of printing a document image on a printing medium (a printing sheet, OHP sheet, or the like), a print function of printing data externally supplied via the LAN 2051 on a printing medium, and a communication function including a facsimile function via the WAN 2051. Note that the LAN 2011 and WAN 2051 need only comprise a function of making communications with an external information processing apparatus, and a communication cable complying with an RS232C interface or wireless communications may be used.

The controller unit 2000 has a CPU 2001 which plays central roles in control of the image forming apparatus so as to control respective components of the image forming apparatus, a RAM 2002 used to temporarily hold data in internal processes such as an image process and the like, a ROM 2003 which records software to be executed by the CPU 2001, and a hard disk (HDD) 2004 used to save control programs and image data used in the image forming apparatus. The CPU 2001 starts up a system on the basis of a boot program stored in the ROM 2003. The CPU 2001 then reads out control programs, programs associated with various flowcharts to be described later, programs associated with various kinds of display control to be described later, and the like, which are stored in the HDD 2004, and executes predetermined processes such as processes of the various flowcharts, display control processes, and the like to be described later using the RAM 2002 as a work area.

Furthermore, the controller unit 2000 has an operation unit interface (operation unit I/F) 2006 as an interface with the operation unit 2012, a network interface (network I/F) 2010 as an interface with the LAN 2011, a modem 2050 as an interface with the WAN 2051, an image bus interface (image bus I/F) 2005 as an interface with an image bus 2008 to which blocks that perform image processes are connected, and an IC card slot 2100 as an insertion port of an IC card. The CPU 2001, RAM 2002, ROM 2003, HDD 2004, image bus I/F 2005, operation unit I/F 2006, network I/F 2010, modem 2050, and IC card slot 2100 are connected via a system bus 2007 and can communicate with each other. Note that in this embodiment, the blocks that perform image processes and the image bus 2008 are included in the controller unit 2000.

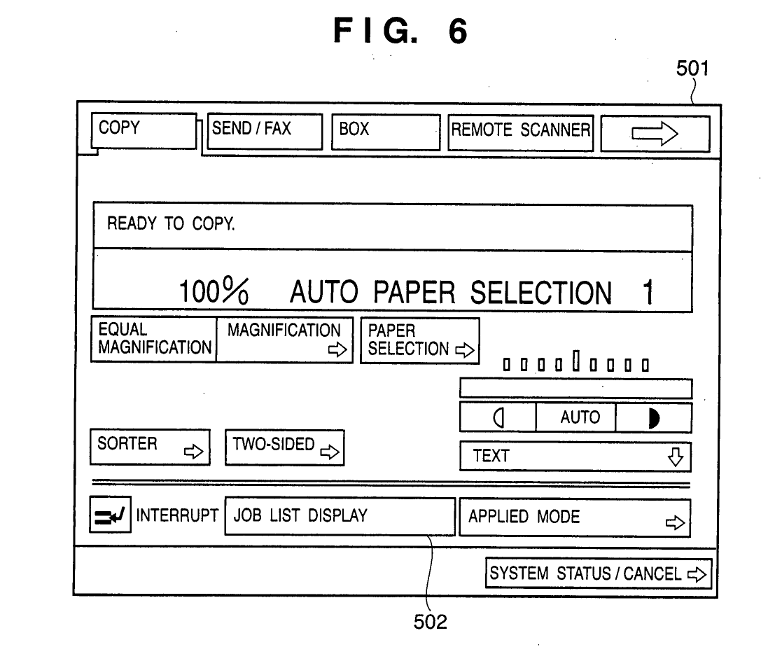

The operation unit 2012 to be controlled by the controller unit 2000 (including the CPU 2001) has a display unit (liquid crystal) 501 which displays an information input screen used to input setting states associated with respective functions of image formation, and setting information associated with respective functions by operations of the operator, a screen that informs the operator of various kinds of guidance information, and the like, and an input unit including a ten-key pad and the like used to input setting information associated with respective functions. In this embodiment, the display unit 501 comprises a touch panel type liquid crystal display unit, and the operator can input various kinds of setting information by touching the display unit (with the finger). FIG. 6 shows an example of a user interface screen which is displayed on the display unit 501 of the operation unit 2012 of the image forming apparatus (202) under the control of the CPU 2001. For example, this screen corresponds to an initial screen of the image forming apparatus 202. The operation unit 2012 exchanges image data to be displayed on it, signals generated by operation inputs, and the like with the controller unit 2000 (CPU 2001).

The image bus I/F 2005 has a bus bridge that connects the image bus 2008 and system bus 2007 and converts data structures. The image bus 2008 comprises a PCI bus that can transfer image data at high speed, a bus complying with IEEE1394, or the like.

The controller unit 2000 has, in the blocks that perform image processes, a raster image processor (RIP) 2060, device interface (device I/F) 2020, scanner image processor 2080, printer image processor 2090, image rotation unit 2030, image compression unit 2040, and encryption/decryption processor 2110. The image bus I/F 2005, RIP 2060, device I/F 2020, scanner image processor 2080, printer image processor 2090, image rotation unit 2030, image compression unit 2040, and encryption/decryption processor 2110 are connected via the image bus 2008 and can communicate with each other.

The RIP 2060 rasterizes PDL code data received via the LAN 2011 or WAN 2051 and PDL code data stored in the HDD 2004 to bitmap image data. Note that the HDD 2004 can store and hold a plurality of types of plurality of print job data such as image data (scan data) of print job data from the scanner 2070, image data which is rasterized to bitmap data on the basis of PDL data received from a host computer, and the like under the control of the controller (CPU 2001), as an example of a storage unit.

The device I/F 2020 connects the scanner 2070 and printer 2095 as the image input/output devices to the controller unit 2000, and converts synchronous and asynchronous systems of image data. In this arrangement, the device I/F 2020 and scanner 2070 are connected via a cable 2071, and the device I/F 2020 and printer 2095 are connected via a cable 2096.

The scanner image processor 2080 applies correction, modification, and edit processes to image data input by the scanner 2070. The printer image processor 2090 applies correction, resolution conversion, and the like to image data to be output to the printer 2095. The image rotation unit 2030 performs a rotation process of image data. The image compression unit 2040 applies a JPEG compression/decompression process to multi-valued image data, and a JBIG, MMR, or MH compression/decompression process to binary image data. The encryption/decryption processor 2110 performs an encryption/decryption of image data.

With the above arrangement, the CPU 2001 of the controller unit 2000 systematically controls access to various devices connected to the system bus 2007 on the basis of respective control programs. The CPU 2001 also performs control for loading image data from the scanner 2070 via the device I/F 2020, applying predetermined processes to the loaded image data, and outputting the image data to the printer 2095 via the device I/F 2020, and so forth.

A box according to this embodiment will be explained below. The HDD 2004 of the image forming apparatus has not only a temporary area used to implement a digital sort function or the like, but also a box area (box) that allows output processes such as a print process, transmission process, and the like of data including image data repetitively during a period until a predetermined condition is met (e.g., until an explicit data erase processing instruction is input from the operator). For example, a plurality of boxes (e.g., 100 boxes) is assured on the box area and can be assigned to respective operators. The boxes include user boxes which can save a plurality of documents scanned by the user, a plurality of PDL images sent from a computer, and the like, a system box which can save a plurality of received FAX documents and the like, and the like. Numbers are assigned to user boxes to identify them. For each user box, a box name and authentication data such as a personal identification number (password) or the like required to limit use of the box can be set. Furthermore, an automatic erase function of automatically erasing image data stored in the box after an elapse of a predetermined period of time, and that predetermined period of time can be set by the operator.

The controller (CPU 2001) of this embodiment controls to store and hold image data scanned by the scanner 2070 of the self apparatus in a desired one, selected by the operator, of the plurality of boxes on the basis of an instruction from the operator input via the operation unit 2012 of the image forming apparatus 202. Also, the controller controls to store and hold PDL image data sent from a computer in a desired one, selected by the operator, of the plurality of boxes on the basis of an instruction from the operator input via the operation unit 2012 of that computer. The controller (CPU 2001) of this embodiment controls to select a plurality of print job data of operator's choice (of course, only one print job data can be selected) in a box of operator's choice of the plurality of boxes, to read out the print job data from the box, and to execute an output process of operator's choice such as a transmission process, print process, or the like. Hence, a document saved in each box can be sent to an external apparatus in a facsimile or e-mail format, can be moved to another box, and can be output to the printer. The image forming apparatus of this embodiment has such box function.

[Device Arrangement]

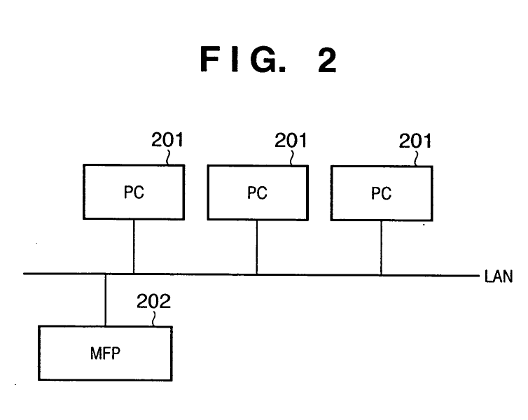

FIG. 2 shows an example of the arrangement of an image forming system having the image forming apparatus (MFP) 202. As shown in FIG. 2, in this embodiment, information processing apparatuses (PC) 201 and the image forming apparatus (MFP) 202 are connected via a LAN and can make data communications with each other. In this arrangement, each PC 201 generates predetermined image data by application software such as a wordprocessor, drawing software, or the like, and generates print job data in its printer driver. The PC 201 sends print job data to the MFP 202.

Note that the MFP 202 of this embodiment has a non-hold print mode that controls the printer 2095 to immediately execute print processing upon reception of the print job data (i.e., a mode for controlling the printer 2095 to start print processing without any print start instruction input by the operator via the operation unit 2012 of the image forming apparatus 202 after print job data to be processed is stored in the HDD 2004 of the image forming apparatus 202). Also, the MFP 202 of this embodiment has a hold print mode that inhibits the printer 2095 from immediately executing print processing upon reception of print job data, and permits the printer 2095 to start print processing in response to a print start instruction input later from the operation unit 2012 (i.e., a mode for controlling the printer 2095 to execute print processing at the time of input of a print start instruction by the operator via the operation unit 2012 of the image forming apparatus 202 after print job data to be processed is stored in the HDD 2004 of the image forming apparatus 202).

For example, upon transmitting print job data from the PC 201, the operator can input an instruction that selects the aforementioned mode together with various printing conditions (the number of copies to be printed, a setting indicating two- or one-sided printing, settings of sheet processes such as a staple process, punch process, sort process, and the like, a setting of a paper size, and the like) of the print job data to be printed, and can send command data including the input instruction and printing conditions to the MFP 202 together with the print job data (image data) to be printed. Upon reception of the print job data, the CPU 2001 of the MFP 202 interprets the instruction of the command data of the print job data, and controls the MFP 202 to selectively execute the hold print mode or non-hold print mode on the basis of this instruction. In the non-hold print mode, the CPU 2001 controls the printer 2095 to directly execute print processing of the print job data via the HDD 2004. On the other hand, in the hold print mode, the CPU 2001 controls the HDD 2004 to save the print job data without printing it, and controls to read out and print the print job data from the HDD 2004 in response to a print start instruction input later from the operation unit 2012.

In this embodiment, upon reading out and printing print job data saved in the HDD 2004 in accordance with operations of the operator at the operation unit 2012, the operator can select not only one print job data but also a plurality of print job data of his or her choice from a plurality of print job data (a plurality of document data) held in the HDD 2004, and the plurality of print job data of operator's choice in the HDD 2004 can be continuously printed by the printer 2095 together.

In addition, the image forming apparatus 202 of this embodiment has a mode (immediate continuous print mode; a continuous print mode in a description given later) of allowing, when a plurality of print job data of operator's choice are to be continuously printed together in this way, to continuously print these print job data together as they are selected to be continuously printed.

Furthermore, the image forming apparatus 202 of this embodiment has a mode (date-designated continuous print mode) of inhibiting, when a plurality of print job data of operator's choice are to be continuously printed together in this way, these print job data from being continuously printed as they are selected to be continuously printed, and allowing to continuously print these print job data together at a timing designated by the operator.

When the operator selects a plurality of independent print job data to be continuously printed via the operation unit 2012, the operator himself or herself can determine via the operation unit 2012 whether the MFP 202 is operated in the continuous print mode or the date-designated continuous print mode of these print modes.

In this embodiment, printing condition information that describes printing conditions (the number of copies to be printed, print density, selected paper, sorter, binding margin, two-sided copy, and the like) set by the operator in a job of each of a plurality of independent print job data., which are saved in the HDD 2004 under the control of the CPU 2001, is generated, and can be stored and held in the HDD 2004 in association with the print job data. Upon printing job data saved in the HDD 2004, the printer 2905 can print the job in accordance with the printing condition information associated with that job.

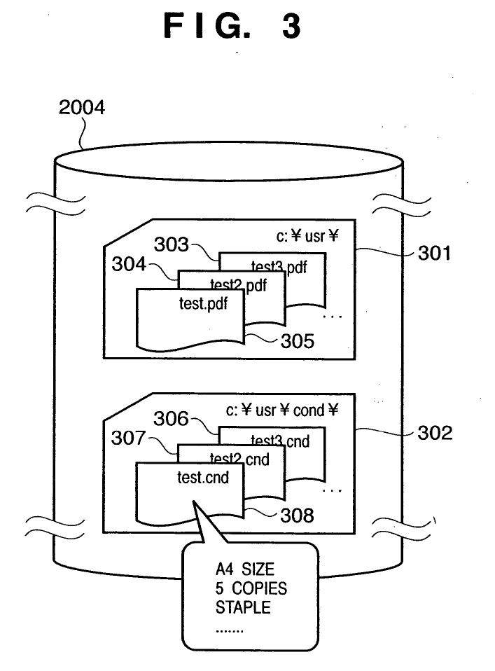

FIG. 3 illustrates the recording state of print job data and printing condition information in the HDD 2004. Print job data 303, 304, and 305 (a series of three image data which are independent from each other) are stored in a print job data folder 301. Printing condition information 306, printing condition information 307, and printing condition information 308 associated with the print job data 303, 304, and 305 are stored in a printing condition information folder 302. The printing condition information 306, printing condition information 307, and printing condition information 308 are set with predetermined initial values (printing conditions set by the operator upon inputting the print job data to the HDD 2004), but their settings can be changed by operations to be described later.

[Processing of MFP]

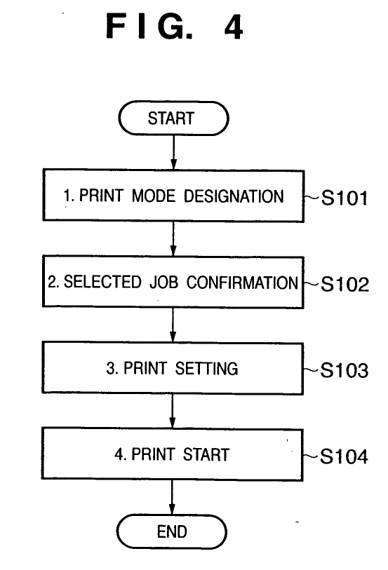

The processing of the MFP 202 that received print job data will be described below. FIG. 4 is a flowchart showing the flow of the overall processing when the MFP 202 prints print job data held in its HDD 2004 under the control of the CPU 2001. Note that the processing programs of flowcharts to be described later, which include this processing, are held in a memory such as the ROM 2003 or the like, and can be read out and executed by the CPU 2001 as needed.

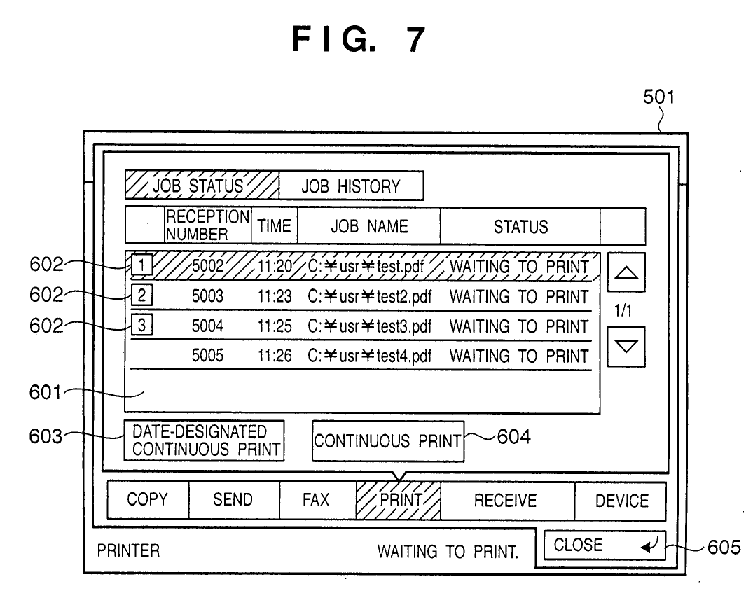

In step S101 in FIG. 4, when the operator presses a job list display key 502 on an operation screen of FIG. 6, which is displayed on the display unit 501 of the operation unit 2012, the controller (CPU 2001) of the MFP 202 controls to display, on the operation unit 2012, an operation screen (that in FIG. 7) which comprises display elements that display, in the form of a list, job information (information for each print job, i.e., the reception number information, reception time, document name, current status, and the like of each print job) of print job data, which are received by the MFP 202 and are saved in the HDD 2004.

The controller prompts the operator to select print job data to be printed in the HDD 2004 via the operation screen in FIG. 7. In addition, the controller prompts the operator to, e.g., designate the print mode of the print job data selected by him or her (1. print mode designation).

In this embodiment, the operator can select not only one print job data to be printed but also a plurality of print job data from those in the HDD 2004 via the operation unit 2012. In the display example of FIG. 7, in a situation in which there are four print job data as independent print job data held in the HDD 2004, the operator selects three independent print job data of these print job data.

The selection method of print job data will be described below. As shown in FIG. 7, the CPU 2001 controls the operation unit 2012, so that a job list display area 601 displays job information of respective print job data in the form of a list, and the operator can select desired print job data by pressing print job data displayed in the list by a touch panel operation. In response to operator's touch on a display line of print job data in this list, the CPU 2001 determines that the operator selects that print job data, and controls the operation unit 2012 to reverse display of job information corresponding to the that print job data on the list. When the operator presses the display line of the print job data selected by him or her again, the CPU 2001 cancels selection of that print job data.

When the operator settles his or her operation after he or she selects only one print job data on the list display area in FIG. 7, the CPU 2001 controls the printer to print only one print job data selected by the operator of those in the HDD 2004 in response to this operation (to select a single job print sequence). On the other hand, when the operator settles his or her operation after he or she selects a plurality of print job data on the list display area in FIG. 7, the CPU 2001 controls the printer 2095 to execute a multiple job continuous print operation for continuously printing the plurality of print job data selected by the operator of those in the HDD 2004 together in response to this operation (to select a multiple job continuous print sequence).

Furthermore, in this embodiment, when the operator selects a plurality of independent print job data, as shown in FIG. 7, the CPU 2001 controls to continuously print these print job data together. In this case, the CPU 2001 controls to allow the operator to arbitrarily set a print order of the plurality of print job data to be continuously printed. For example, the CPU 2001 controls the operation unit 2012 to allow the operator to select desired print job data on the job list display area 601 in FIG. 7, but also to allow the operator to determine the print order of a plurality of print job data to be continuously printed on the job list display area 601 when the operator selects these print job data on the job list display area 601. In the display example of FIG. 7, the selected state of the first to third print job data from the top of the four print job data is presented to the operator via the job list display area 601, and “1”, “2”, and “3” are displayed on the left side of these data. This indicates the selection order when the operator selects print job data one by one in turn from the top, and the CPU 2001 controls the printer to continuously print these three print job data according to this order in which the operator selects them.

When the operator presses a copy start key (not shown) on the operation unit 2012 while he or she selects only one print job data on the job list display area 601, the CPU 2001 controls the printer 2095 to print the selected one print job data.

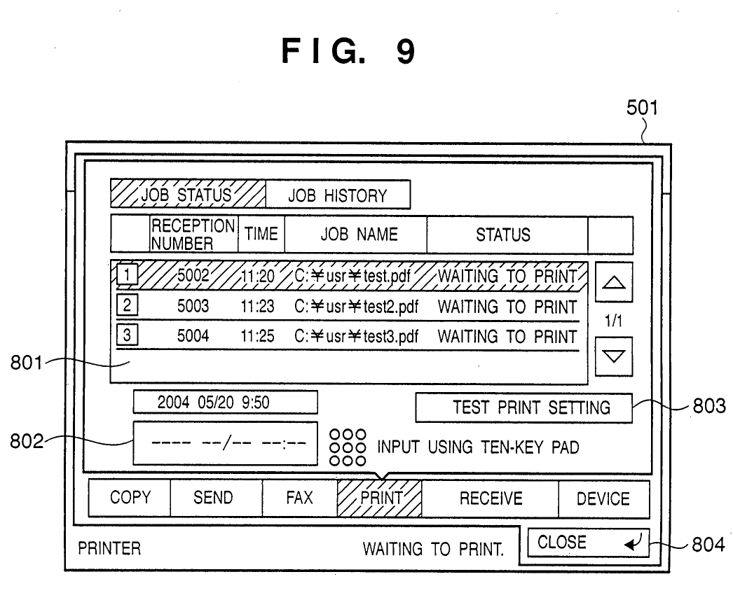

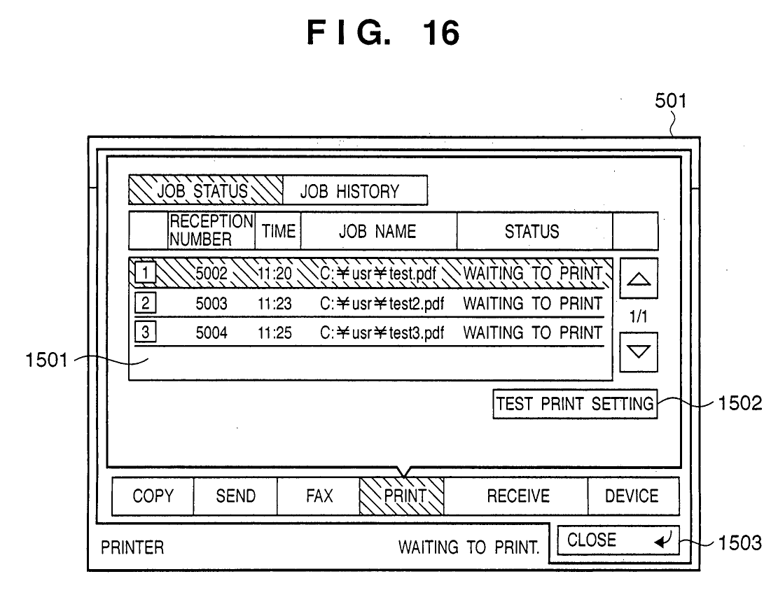

After the operator has done the print job data selection process and the designation of the print mode via the operation unit 2012 in step S101, the flow then advances to step S102. In step S102, the controller (CPU 2001) of the MFP 202 controls the operation unit 2012 to switch the display contents of its display unit to an operation screen (that in FIG. 9 or 16) that displays, in the form of a list, job information of the plurality of print job data selected by the operator as those to be continuously printed in the HDD 2004 via the operation screen of FIG. 7, and makes the operator confirm the print job data selected as those to be printed via this display (2. selected job confirmation). If the “date-designated continuous print” mode (to be described later) is selected, the MFP 202 further prompts the operator to set the print start date and time via the operation unit 2012 in this step.

Upon completion of the settings by the operator, the flow advances to step S103, and the MFP 202 receives a setting of test print conditions (3. print setting). In this step, the operator repeats test print processing and correction of printing conditions until a desired print result is obtained. After the desired print result is obtained, the operator makes a print reservation. When the date and time designated by the operator are reached, the MFP 202 starts print processing in step S104 (4. print start).

Details of the processes in the respective steps will be described below.

(1. Print Mode Designation)

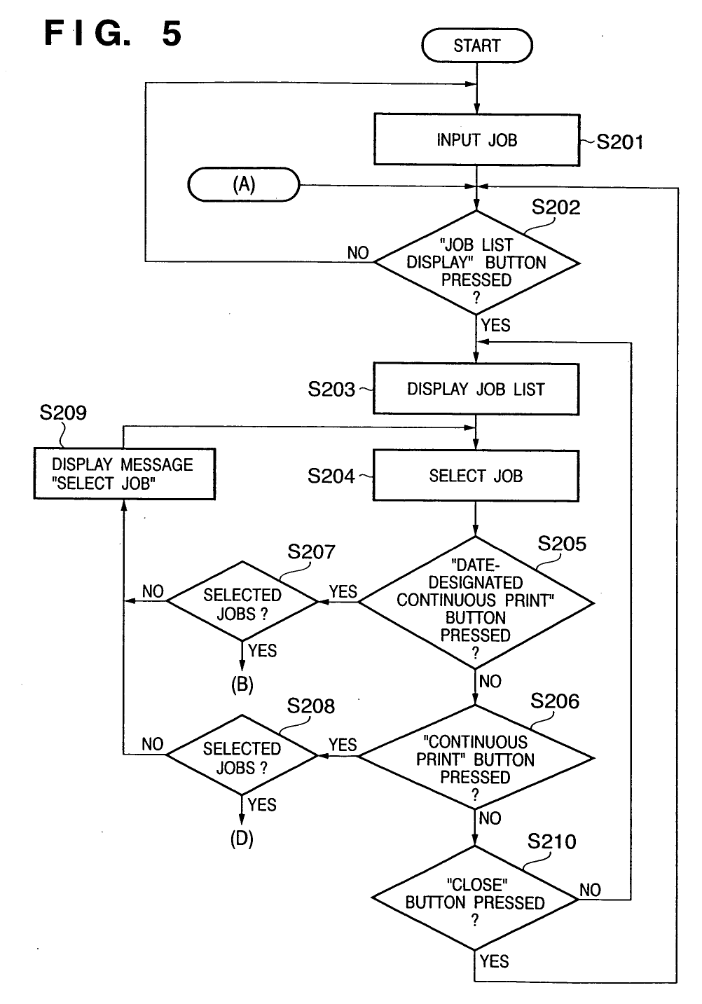

The operation of print mode designation in this embodiment will be described below. FIG. 5 is a flowchart showing the flow of processing from when print job data is input to the MFP 202 until the operator designates the print mode. A series of processes in FIG. 5 correspond to details of the processing in step S101 in FIG. 4.

If print job data is input to the MFP 202 (step S201), the operator can make various settings about print processing of the print job data by operating the operation unit 2012 of the MFP 202.

FIG. 6 shows the basic screen of the display unit 501 included in the operation unit 2012 of the MFP 202. As described above, in this embodiment, the display unit 501 is of a touch panel type, and the operator can input information by touching the display unit 501. The CPU 2001 also executes various kinds of display control on the display unit 501 as one element of the operation unit 2012.

If the operator presses the job list display key 502 displayed on the display unit 501 (YES in step S202), the CPU 2001 controls the display unit 501 to execute list display of print job data input to the MFP 202, as shown in FIG. 7 (step S203).

FIG. 7 shows the state of the operation screen of list display of print job data input to the MFP 202. The operation screen of FIG. 7 has the job list display area 601 at the center as its display element, and the CPU 2001 controls the display unit 501 to display information such as the reception number, input time, print job data name, print status, and the like of the print job data input to the MFP.202 in that area.

If the operator presses a field (display line) where the information of print job data is displayed by a touch panel operation, the CPU 2001 determines that the operator selects that print job data, notifies the operator of selection of that print job data, and controls to display an icon 602, which notifies the operator of the print order of that print job data, near the left side of job information corresponding to that print job data on the job list display area 601.

The operator can select a plurality of print job data at the same time. If a plurality of jobs are selected, the CPU 2001 controls the printer 2095 to print these jobs in the same order as that in which the operator selects these jobs. That is, the continuous print processing of these plurality of jobs can be performed in an output order of operator's choice irrespective of the order in which these jobs are input to the HDD 2004. In this way, the operator selects print job data whose printing conditions are to be set (step S204).

If the operator selects only one job via the job list display area 601, the CPU 2001 controls the MFP 202 to read out only that job from the HDD 2004 and to print that job by the printer. On the other hand, if the operator selects a plurality of jobs via the job list display area 601, the CPU 2001 controls the MFP 202 to read out job data corresponding to these plurality of jobs in the HDD 2004 from the HDD 2004 in the order in which the operator selects them on the job list display area 601, and to continuously print these jobs together by the printer.

After the operator selects the print job data, the CPU 2001 allows the operator to designate the print mode. In this embodiment, when the operator selects a plurality of print job data as job data to be printed on the job list display area 601, the CPU 2001 controls to handle these print job data as those to be continuously printed. In this case, the MFP 202 has two different modes, i.e., the “date-designated continuous print” mode and “continuous print (immediate continuous print)” mode, so as to allow the operator to select the continuous print timing of these plurality of jobs to be continuously printed as the product specification for POD. In the “date-designated continuous print” mode, the operator can make a print reservation by designating the date and time at which the printer 2095 is scheduled to start the continuous print processing of a plurality of print job data selected by the operator as those to be continuously printed in the HDD 2004. In the “continuous print (immediate continuous print)” mode, the continuous print processing of a plurality of print job data selected by the operator as those to be continuously printed in the HDD 2004 can be started immediately after the operator sets printing conditions. Although the continuous print processing immediately starts, if execution of the print processing of another job is in progress by the MFP 202, the control waits for completion of the print operation of that job, and the continuous print processing then starts. In this specification, the processing in the “date-designated continuous print” mode will be described first, and that in the “continuous print (immediate continuous print)” mode will then be described.

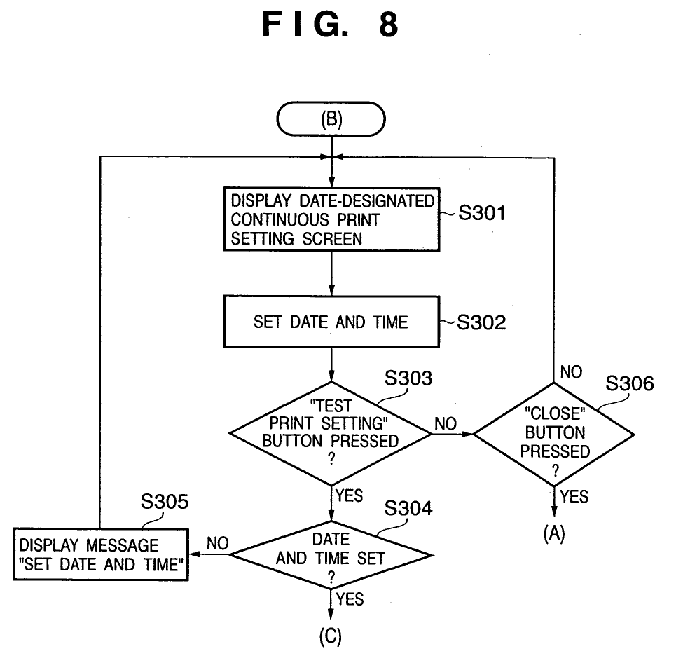

The print mode can be designated when the operator presses a date-designated continuous print key 603 or continuous print key 604 on the operation screen of FIG. 7 displayed on the display unit 501 under the control of the CPU 2001. Upon depression of the date-designated continuous print key 603 (YES in step S205), the flow advances to step S207, and the CPU 2001 checks if selected print job data are present. If the selected print job data are present (YES in step S207), the CPU 2001 settles the “date-designated continuous print” mode, and the flow advances to step S301 in FIG. 8. In this case, the CPU 2001 controls the display unit 501 to display a date-designated continuous print setting screen shown in FIG. 9.

In this embodiment, in order to obtain the effect of improving the operator's convenience, the CPU 2001 executes the display control of FIG. 9. As shown in the display example of FIG. 9, when an instruction that designates to continuously print a plurality of jobs in the HDD 2004 and to execute that continuous print operation at the date and time designated by the operator is received from the operator (when a plurality of jobs are selected on the UI in FIG. 7 and the date-designated continuous print key 603 is input), the screen shown in FIG. 9 is displayed. This screen comprises not only an instruction field 802 which makes the operator set the start date and time of the continuous print operation, but also a selected job list display area 801 which notifies the operator of information that allows him or her to confirm jobs to be continuously printed in the HDD 2004. Upon observing the selected job list display area 801, the operator can recognize jobs to be continuously printed of those which present job information on the job list display area 601 in FIG. 7.

If no selected print job data is present (NO in step S207), a message “select print job data” is displayed on the display unit 501 (step S209), and the flow returns to step S204.

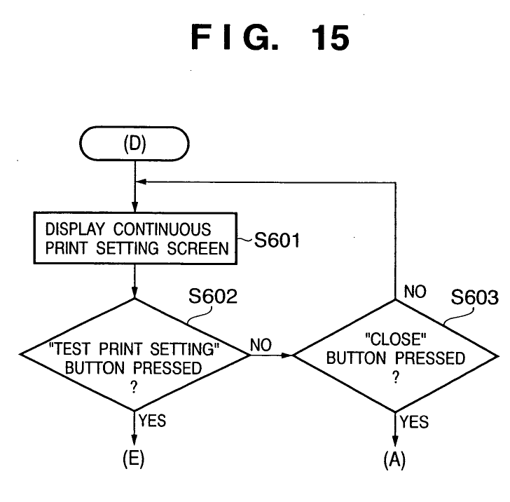

If the operator presses the continuous print key 604 (YES in step S206) after he or she selects print job data (step S204), the flow advances to step S208 and the CPU 2001 checks if selected print job data are present. If the selected print job data are present (YES in step S208), the CPU 2001 settles the “continuous print” mode, and the flow advances to step S601 in FIG. 15. In this case, the CPU 2001 controls the display unit 501 to display a selected print job data confirmation screen shown in FIG. 16. As for the display control of the setting screen in FIG. 16, in order to improve the operability as in the display control of the screen in FIG. 9, the screen in FIG. 16 comprises a selected job list display area 1501 which allows the operator to confirm jobs to be continuously printed of those in the HDD 2004 in distinction from other jobs. If no selected print job data is present (NO in step S208), a message “select print job data” is displayed on the display unit 501 (step S209), and the flow returns to step S204.

If the operator presses a close key 605 (YES in step S210), the flow returns to step S202 to display the basic screen shown in FIG. 6 on the display unit 501.

<Processing of “Date-Designated Continuous Print” Mode>

(2. Selected Job Confirmation)

The operation of selected job confirmation in the “date-designated continuous print” mode will be described below. FIG. 8 is a flowchart showing the flow of processing for confirming the selected print job data and designating the print start date and time when the operator selects the “date-designated continuous print” mode. A series of processes correspond to details of the processing in step S102 in FIG. 4.

In step S301, the CPU 2001 controls the display unit 501 of the operation unit 2012 to display the date-designated continuous print setting screen shown in FIG. 9. Also, the CPU 2001 controls to display a list of print job data to be continuously printed, which are selected by the operator, on the selected job list display area 801 on the display unit 501. The operator can confirm that the print job data selected via the screen in FIG. 7 are correctly selected as jobs to be continuously printed.

In step S302, the CPU 2001 prompts the operator to set the print start time of the print job data. The print start time is set on the time setting field 802 on the screen in FIG. 9. The operator inputs the print start time by operating the ten-key pad (not shown) of the operation unit 2012. The input information is displayed on the time setting field 802. Note that the CPU 2001 controls the display unit 501 to display the current date and time above the time setting field 802.

Furthermore, the CPU 2001 controls the MFP 202 to allow the operator to designate, via the screen of FIG. 9, the print start time of the continuous print operation to be executed by the printer 2095 of a plurality of jobs selected by the operator via the screen of FIG. 7, and to select, via a test print setting key 803 on the screen of FIG. 9, whether or not the printer 2095 executes test print processing of the jobs to be continuously printed.

For example, a practical control example of the CPU 2001 for the MFP 202 in case of operator's settings shown in FIGS. 7 and 9 will be explained below.

Assume that four jobs, i.e., a job with a job name “C:¥usr¥test.pdf” (to be referred to as job 1 hereinafter), a job with a job name “C:¥usr¥test2.pdf” (to be referred to as job 2 hereinafter), a job with a job name “C:¥usr¥test3.pdf” (to be referred to as job 3 hereinafter), and a job with a job name “C:¥usr¥test4.pdf” (to be referred to as job 4 hereinafter), have already been stored as hold jobs in the HDD 2004 under the control of the CPU 2001.

In this embodiment, as has been explained above using FIG. 3, when job data is input to the HDD 2004 as an example of a storage unit which can store a plurality of jobs, the CPU 2001 controls to store, in the HDD 2004, job information such as information indicating the number of pages, information indicating a job name, information indicating the reception time of the job, information indicating the reception number, and the like, for each job. In addition, the CPU 2001 controls to store, in the HDD 2004, information indicating printing conditions used to print each job (the number of copies to be printed, paper size, document size, density, settings of finishing such as a staple process, punch process, bookbinding process, sort process, and the like, a setting of two- or one-sided printing, a setting associated with an image edit process, and the like) for each job.

As this printing condition information, for example, if a job is input from the scanner, the CPU 2001 acquires print setting information set by the operator via the operation unit 2012 from the operation unit 2012. When a job is input from an external apparatus such as a computer or the like, the CPU 2001 acquires information generated based on printing condition information, which is received together with image data upon reception of the image data of that job from the external apparatus and is set by the operator at the operation unit (e.g. a printer driver) of the external apparatus. The CPU 2001 stores the printing conditions in the HDD 2004 in association with the job.

Upon reading out image data of each job from the HDD 2004 and printing the readout image data by the printer 2095, the CPU 2001 controls to execute the print operation on the basis of the printing conditions which are stored in advance together with the image data upon storing the image data of the job in the HDD 2004, and are set by the operator.

Note that not only the printing conditions can be set upon inputting a job to the HDD 2004 but also they can be set by the operator via the operation unit 2012 as needed upon reading out and printing a job from the HDD 2004.

Based on the above description, a description will revert to that of the practical control example. Assume that job 1 stored in the HDD 2004 is document data including two pages, and the operator has made the settings of the printing conditions of job 1: the number of copies to be printed=50 copies (first printing condition parameter); the print paper size=A3 (second printing condition parameter); a designation of one- or two-sided printing=one-sided printing (third printing condition parameter); and a finishing setting=execution of a sort process (fourth printing condition parameter). Also, assume that job 2 is document data including four pages, and the operator has made the settings of the printing conditions of job 2: the number of copies to be printed=30 copies (first printing condition parameter); the print paper size=A4 (second printing condition parameter); a designation of one- or two-sided printing=two-sided printing (third printing condition parameter); and a finishing setting=execution of a punch process (fourth printing condition parameter). Assume that job 3 is document data including three pages, and the operator has made the settings of the printing conditions of job 3: the number of copies to be printed=20 copies (first printing condition parameter); the print paper size=A4 (second printing condition parameter); a designation of one- or two-sided printing=one-sided printing (third printing condition parameter); and a finishing setting=execution of a staple process (fourth printing condition parameter). Likewise, assume that various printing conditions of job 4 have been set.

When the aforementioned independent four jobs are stored in the HDD 2004, the CPU 2001 controls the display unit 501 to display the operation screen of FIG. 7, as a display that prompts the operator to select desired jobs from those held in the HDD 2004, upon depression of the job list display key 502 by the operator on the operation screen of FIG. 6.

When the operator touches display lines of job information in the order of job 1, job 2, and job 3 on the job list display area 601 on the screen of FIG. 7, the CPU 2001 determines that these jobs 1, 2, and 3 are those to be continuously printed. Note that the operator can select the job print order, as described above, and this embodiment adopts an order in which the operator selects jobs as those to be continuously printed. Hence, in this case, the CPU 2001 makes job scheduling to execute printing of job 1→printing of job 2→printing of job 3 as the continuous print operation. That is, if the operator designates the print order in an order of job 1, job 3, and job 2, the CPU 2001 makes job scheduling to execute printing of job 1→printing of job 3→printing of job 2 as the continuous print operation.

When the operator has pressed the date-designated continuous print key 603 after he or she has made the above operations, the CPU 2001 controls to switch the display contents of the display unit 501 to those in FIG. 9 so as to allow the operator to set the execution timing of the continuous print operation of the plurality of jobs (jobs 1, 2, and 3) selected by the operator.

When the operator sets, e.g., “May 20, 2004 23:00” via the time setting field 802 on the screen of FIG. 9 and the ten-key pad of the operation unit 2012, the CPU 2001 executes the continuous print operation of respective data of jobs 1, 2, and 3 in the HDD 2004 automatically (as if the operator were operating the operation unit 2012 of the MFP 202 to input a print instruction and the like at the designated date and time) at the designated date and time (e.g., at the timing “May 20, 2004 23:00” as that 13 hours 50 minutes elapsed from the current date and time “May 20, 2004 9:50” in the example shown in FIG. 9) in accordance with the printing conditions set by the operator.

That is, in this example, the CPU 2001 reads out image data of job 1 including two pages and its printing conditions from the HDD 2004 at the designated date and time (in this example, May 20, 2004 23:00), controls the printer 2095 to execute a one-sided print operation that prints image data of the first and second pages of that job on A3 printing sheets for respective pages and to repeat that operation for 50 copies, and controls a sheet processing device (not shown) of the MFP 202 to execute a sort process for respective output bundles as a finishing process.

Upon completion of the print processing of job 1, the CPU 2001 then reads out image data of job 2 including four pages and its printing conditions from the HDD 2004, controls the printer 2095 to execute a two-sided print operation which prints image data of the first and second pages of job 2 on two faces of the first A4 printing sheet, and similarly prints image data of the third and fourth pages on two faces of the second printing sheet and to repeat that operation for 30 copies (30 sets), and controls the sheet processing device to execute a punch process of these output bundles as a finishing process.

Upon completion of the print processing of job 2, the CPU 2001 then reads out image data of job 3 including three pages and its printing conditions from the HDD 2004, controls the printer 2095 to execute a one-sided print operation that prints image data of the first, second, and third pages of that job on A4 printing sheets for respective pages and to repeat that operation for 20 copies, and controls the sheet processing device to execute a staple process for respective output bundles as a finishing process. Upon completion of the print processing of job 3, the CPU 2001 determines that the continuous print operation of the plurality of jobs is complete.

The CPU 2001 controls the MFP 202 to execute the aforementioned continuous print operation of the plurality of jobs at the designated date and time. When the operator inputs an immediate print instruction via the continuous print key 604 in place of the date-designated continuous print key 603 on the operation screen of FIG. 7, the CPU 2001 controls the MFP 202 to immediately execute the aforementioned multiple job continuous print operation of jobs 1, 2, and 3. That is, in this example, the CPU 2001 controls the MFP 202 to execute the aforementioned continuous print operation at May 20, 20049:50. When processing of another job (e.g., job 4) is in progress, the CPU 2001 controls to execute the continuous print operation of jobs 1, 2, and 3 after completion of the print processing of that job.

In this embodiment, on the assumption of the above arrangement, the CPU 2001 controls the MFP 202 to further execute the following operation as a scheme that can solve the conventional problems, and exhibits effects especially in POD. The following description will be given continuously using the aforementioned control example.

For example, in this embodiment, while the operation screen of FIG. 9 is displayed on the display unit 501 and the operator makes settings in FIG. 9 (in this example, a case wherein the operator selects and sets jobs 1, 2, and 3 as those to be continuously processed in the print order of job 1→job 2→job 3), the operator can input a test print instruction of these jobs 1, 2, and 3 to be continuously printed to the MFP 202 via the test print setting key 803.

When the operator inputs a test print instruction of the plurality of jobs via the test print setting key 803 after he or she has made the above job settings, the CPU 2001 controls the MFP 202 to continuously execute test print processing of job 1, that of job 2, and that of job 3 together as the continuous test print operation of the plurality of jobs before the date and time (in this example, May 20, 2004 23:00) are reached, i.e., before execution of the continuous print operation, so that the operator can confirm the print results of jobs 1, 2, and 3 to be continuously printed, and when the operator decides that unwanted print results are obtained after he or she confirms them, the operator can change the printing conditions via the operation unit 2012 to execute the continuous print operation based on the changed printing conditions.

For example, in this case, at the current time (May 20, 2004 9:50) as the input timing of the test print instruction of the plurality of jobs by the operator via the test print setting key 803, the CPU 2001 controls to continuously execute the following test print processing of jobs 1, 2, and 3 in the following order.

Initially, the CPU 2001 reads out image data of job 1 including two pages and its printing conditions from the HDD 2004, and controls the printer to execute a one-sided print operation that prints image data of the first and second pages of that job on A3 printing sheets for respective pages so as to obtain such print result for one copy as the predetermined number of copies, independently of the first printing condition parameter, i.e., the number of copies to be output=50, which is set by the operator.

Upon completion of the test print processing of job 1, the CPU 2001 then reads out image data of job 2 including four pages and its printing conditions from the HDD 2004, controls the printer 2095 to execute a two-sided print operation which prints image data of the first and second pages of job 2 on two faces of the first A4 printing sheet, and similarly prints image data of the third and fourth pages on two faces of the second printing sheet so as to obtain such print result for, e.g., one copy as in the above case, and controls the sheet processing device to execute a punch process of an output bundle as a finishing process.

Upon completion of the test print processing of job 2, the CPU 2001 then reads out image data of job 3 including three pages and its printing conditions from the HDD 2004, controls the printer 2095 to execute a one-sided print operation that prints image data of the first, second, and third pages of that job on A4 printing sheets for respective pages so as to obtain such print result for one copy as in the above case, and controls the sheet processing device to execute a staple process for an output bundle as a finishing process. Upon completion of the test print processing of job 3, the CPU 2001 determines that the continuous test print operation of the plurality of jobs to be continuously printed is complete. With this control, prior to execution of an actual continuous print operation, the operator can confirm the print results of the plurality of jobs to be continuously printed in advance.

In this embodiment, the CPU controls to print each of a plurality of jobs to be processed in the continuous test print operation for one copy irrespective of the condition of the number of copies to be printed of each job. This is a function which considers the operator's merit and is incorporated as a scheme for obtaining an effect that allows test print processing of a plurality of jobs without wasting resources as much as possible, paying attention to the fact that at least one copy need only be output when the operator confirms whether or not his or her desired print result is obtained.

Hence, upon processing a plurality of jobs in the continuous test print operation, each job need not always be printed for one copy. If the operator can check whether or not the print result is appropriate by printing only one page in place of one copy (if he or she wants to check, e.g., only color appearance in case of color printing), only one page may be test-printed for each job. In this way, design changes are allowed as needed in correspondence with the use environment of the operator.

Also, in this embodiment, in order to improve the operator's convenience, the CPU 2001 controls to allow the operator to set the order of print operations of a plurality of jobs to be continuously printed when he or she selects jobs (for example, the operator can set the print order via the key 602 on the operation screen of FIG. 7).

In this embodiment, as another scheme that can further improve the operator's convenience, the CPU 2001 controls to determine the execution order of test print operations of a plurality of jobs on the basis of the settings of the operator even in the continuous test print operation of the plurality of jobs to be continuously printed.

For example, in this embodiment, the CPU controls to execute the continuous test print operation of a plurality of jobs in the same order as the print order of the plurality of jobs in the c continuous print operation. For example, in the above example, the operator selects jobs 1, 2, and 3 as those to be continuously printed via the operation unit 2012, and also sets the print order so that these jobs are to be continuously printed in the order of job 1→job 2→job 3. When the operator inputs a continuous test print instruction via the test print setting key 803 after he or she has made the above settings, the CPU 2001 controls to execute test print processing of job 1, that of job 2, and that of job 3 in turn to have the same order as the print order in the continuous print operation, in the continuous test print operation of these jobs 1, 2, and 3. Therefore, if the operator selects jobs in the order of job 1, job 3, and job 2 via the operation unit 2012 and sets to execute the continuous print operation in the continuous print order of job 1→job 3→job 2, the CPU 2001 controls the MFP 202 to execute the continuous test print operation of these jobs in the test print order of test print processing of job 1→that of job 3→that of job 2. Since this control is also a specification that aims at further improving the operator's convenience, it is not always an indispensable constituent element.

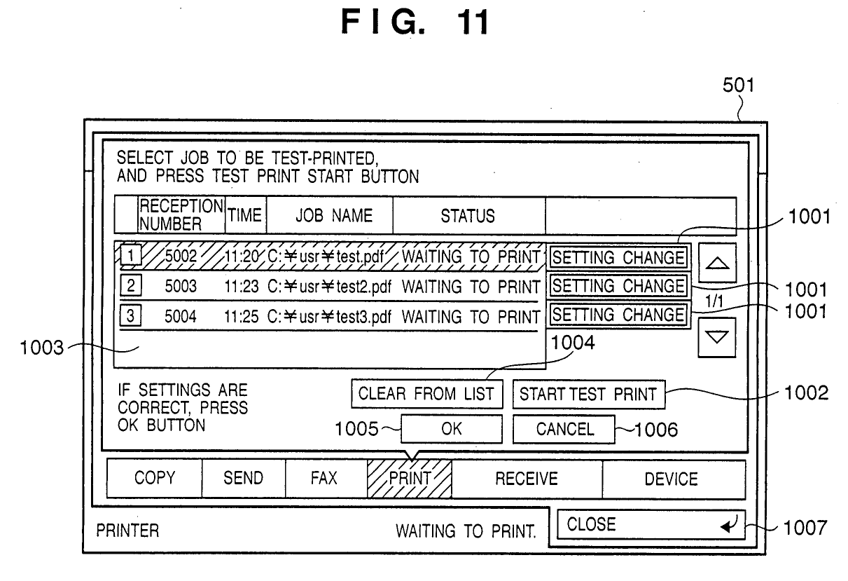

After the MFP 202 executes the continuous test print operation of the plurality of jobs, the CPU 2001 controls to allow the operator, who confirmed the print results of the plurality of jobs obtained by the continuous test print operation, i.e., jobs 1, 2, and 3 in this example, to independently change settings of the printing conditions of jobs 1, 2, and 3 for each job via the operation unit 2012 (to allow the operator to change the settings of the printing conditions of each job via a setting change key 1001 in FIG. 11 to be described later).

For example, assume that the operator who confirmed the print results of jobs 1, 2, and 3 sets to “change from the sort process to a staple process” in association with the finishing setting as the fourth printing condition parameter, as a change of the printing conditions of job 1. Assume that the operator sets to “change from the two-sided printing setting to a one-sided printing setting” in association with the print face setting as the third printing condition parameter of the job, as a change of the printing conditions of job 2. Furthermore, assume that the operator sets to “change the setting for printing on A4 printing sheets to that for printing A3 printing sheets” in association with the print paper size setting as the third printing condition parameter of the job and to “change the one-sided printing setting to a two-sided printing setting” in association with the print face setting as the third printing condition parameter of the job, as changes of the printing conditions of job 3.

After these setting changes of the printing conditions of the plurality of jobs to be continuously printed, the CPU 2001 controls the MFP 202 to execute the following processes in the continuous print operation.

Initially, the CPU 2001 reads out image data of job 1 including two pages and its printing conditions after the setting changes from the HDD 2004, controls the printer 2095 to execute a one-sided print operation that prints image data of the first and second pages of that job on A3 printing sheets for respective pages and to repeat that operation for 50 copies, and controls the sheet processing device to execute a sort process for respective output bundles as a finishing process after the setting changes.

Upon completion of the print processing of job 1 in the continuous print operation of the plurality of jobs, the CPU 2001 then reads out image data of job 2 including four pages and its printing conditions from the HDD 2004, controls the printer 2095 to execute a one-sided print operation that prints image data of the first, second, third, and fourth pages of that job on A4 printing sheets for respective pages and to repeat that operation for 30 copies (30 sets), and controls the sheet processing device to execute a punch process of these output bundles as a finishing process.

Upon completion of the print processing of job 2, the CPU 2001 then reads out image data of job 3 including three pages and its printing conditions from the HDD 2004, controls the printer to execute a two-sided print operation which prints image data for two pages, i.e., the first and second pages of that job on two faces of the first A3 printing sheet, and similarly prints image data of the third page on one face of the second A3 printing sheet and to repeat that operation for 20 copies, and controls the sheet processing device to execute a staple process for respective output bundles as a finishing process. Upon completion of the print processing of job 3, the CPU 2001 determines that the continuous print operation of the plurality of jobs in accordance with the printing conditions whose settings have been changed by the operator based on the test print results of the plurality of jobs is complete.

In the above example, since the date-designated continuous print mode is designated, the continuous print operation according to the printing conditions whose settings have been changed by the operator based on the test print results of the plurality of jobs is controlled to be executed at the date and time designated by the operator (in this example, May 20, 2004 23:00). However, when the operator inputs an immediate print instruction via the continuous print key 604 on the screen of FIG. 7, the continuous print operation after the setting changes is controlled to be executed immediately after the operator changes the settings (in this example, at May 20, 2004 9:50).

In this embodiment, as a scheme for improving the convenience, the following control can be further executed.

For example, when the operator who confirmed the test print results of jobs 1, 2, and 3 does not find any problems in the print results and wants to execute the continuous print operation of these jobs under these printing conditions (without changing the printing conditions, he or she can input an instruction to execute the continuous print operation without changing any settings via the operation unit 2012.

In this case the CPU 2001 controls the MFP 202 to execute the following processes for respective jobs in the continuous print operation of jobs 1, 2, and 3.

Initially, the CPU 2001 reads out image data of job 1 including two pages and its printing conditions from the HDD 2004, controls the printer to execute a one-sided print operation that prints image data of the first and second pages of that job on A3 printing sheets for respective pages and to repeat that operation for 49 copies (=50−1, i.e., for the number of copies to be output obtained by subtracting one copy from the that set as the first printing condition parameter of job 1 by the operator), and controls a sheet processing device (not shown) of the MFP 202 to execute a sort process for respective output bundles as a finishing process.

Upon completion of the print processing of job 1, the CPU 2001 then reads out image data of job 2 including four pages and its printing conditions from the HDD 2004, controls the printer 2095 to execute a two-sided print operation which prints image data of the first and second pages of job 2 on two faces of the first A4 printing sheet, and similarly prints image data of the third and fourth pages on two faces of the second printing sheet and to repeat that operation for 29 copies (=30−1, i.e., for the number of copies to be output obtained by subtracting one copy from the that set as the first printing condition parameter of job 2 by the operator), and controls the sheet processing device to execute a punch process of these output bundles as a finishing process.

Upon completion of the print processing of job 2, the CPU 2001 then reads out image data of job 3 including three pages and its printing conditions from the HDD 2004, controls the printer 2095 to execute a one-sided print operation that prints image data of the first, second, and third pages of that job on A4 printing sheets for respective pages and to repeat that operation for 19 copies (=20−1, i.e., for the number of copies to be output obtained by subtracting one copy from the that set as the first printing condition parameter of job 1 by the operator), and controls the sheet processing device to execute a staple process for respective output bundles as a finishing process. Upon completion of the print processing of job 3, the CPU 2001 determines that the continuous print operation of the plurality of jobs is complete.

As described above, in this embodiment, when no printing conditions are changed after test print operation of jobs to be continuously printed, the CPU 2001 controls to print a number of copies to be output in the continuous print operation by the number of copies to be output obtained by subtracting the number of copies to be output printed in the test print operation from that set by the operator, so that when no settings are changed for jobs which have been processed by the continuous test print operation, output bundles obtained by the test print processing can be used as formal final products, thereby preventing generation of the wasteful print results and improving the cost performance.

In the above example, if the operator has changed the printing conditions of jobs 1 and 3 of jobs 1 to 3 but has not change those of job 2 via the test print processing, the CPU 2001 controls to print 50 copies of image data of job 1 corresponding to the number of copies to be output set for job 1 by the operator under the printing conditions of job 1 after the setting changes, and also to print 20 copies of image data of job 3 corresponding to the number of copies to be output set for job 3 by the operator under the printing conditions of job 3 after the setting changes. On the other hand, as for job 2, the CPU 2001 controls to execute print processing according to parameters (second, third, and fourth printing condition parameters) except for the first printing condition parameter of those set for job 2 in advance before the test print processing, for 29 copies (=30−1, i.e., the number of copies to be output obtained by subtracting one copy from the that set as the first printing condition parameter of job 2 by the operator). In addition, the CPU 2001 controls to execute the continuous print processing of these jobs in the order of job 1→job 2→job 3 as the output order selected by the operator.

With such arrangement, various needs of the operator can be flexibly met while preventing the conventional problems.

Note that in the commercial print service, a situation in which the operator (order receiver of jobs) who operates in the system confirms the test print results, while a client (orderer of jobs; delivery destination) who ordered the processing of jobs to the operator confirms the final products as main print results is assumed. In consideration of such situation, the CPU may control the MFP 202 to continuously print a number of copies designated by the operator even when the operator does not change any settings.

That is, this control will be described below using the above example. When jobs 1, 2, and 3 are to be formally printed while no settings of jobs 1, 2, and 3 are changed after the test print processing of these jobs, the CPU 2001 may control the MFP 202 to print 50, 30, and 20 copies of these jobs under the initially set printing conditions. With this arrangement, the above effects can be further improved, and the convenience upon continuously printing a plurality of jobs can be further improved.

In order to further improve the convenience, for example, the following arrangement may be adopted.

That is, when the operator selects a plurality of jobs as those to be continuously printed, and inputs a continuous test print instruction for the selected jobs via the operation unit 2012, the CPU 2001 controls the MFP 202 to execute the continuous test print processing of these jobs selected as those to be continuously printed, as described above. In this case, even when the MFP 202 receives another job, the MFP 202 may be controlled to inhibit the print operation of that job during the continuous test print processing. In this way, a problem posed when an externally input, unrelated job is printed, and the operator is confused during the continuous test print processing can be prevented.

For example, such control will be described below using the above example. After the operator selects jobs 1, 2, and 3 as those to be continuously printed via the screen of FIG. 7 and inputs a continuous test print instruction of jobs 1, 2, and 3 via the test print setting key 803 on the screen of FIG. 9 or a test print setting key 1502 on the screen of FIG. 16 and the operation unit 2012, when another operator inputs a print instruction of job 4 as another job which is not those to be continuously printed, the CPU 2001 inhibits the print processing of job 4 from being executed during a period from the beginning of the test print processing of job 1 until completion of that of job 3 (during execution of test print processing of job 1→that of job 2→that of job 3). Note that the CPU 2001 controls the scanner and memory to execute the input process of image data of job 4 and its storage process in the HDD 2004 parallel to (simultaneous with) the continuous test print operation even during the print inhibition period of job 4, so as to improve the productivity. After completion of the continuous test print operation, the CPU 2001 controls the MFP 202 to read out image data of job 4 stored in the HDD 2004 during the continuous test print operation from the HDD 2004 and to execute the print operation of job 4.

Furthermore, when the printer 2095 is controlled to execute print processing of another job during the continuous test print operation, the control may be made to inhibit the print processing of another job (interrupt print processing of job 4 in this case) even during the continuous print operation of jobs 1, 2, and 3 to be executed after completion of the continuous test print operation. Alternatively, the CPU 2001 may control the MFP 202 to permit to execute print processing of another job (job 4 in this example) in an interval of neighboring jobs, e.g., a period from completion of the print operation of job 1 until the beginning of that of job 2, a period from completion of the print operation of job 2 until the beginning of that of job 3, or the like.

With the aforementioned control, upon execution of the continuous test print processing of a plurality of jobs to be continuously printed, a problem posed when the print result of a job which is not related to those printed by the continuous test print processing mixes in the print results of the plurality of test-printed jobs on an exhaust unit of the MFP 202 (to explain using the above example, a problem posed when the print result of job 4 mixes in a test-printed printing sheet bundle of job 1, that of job 2, or that of job 3, and/or a problem posed when the print result of job 4 mixes between a test-printed printing sheet bundle of job 1 and that of job 2 or between a test-printed printing sheet bundle of job 2 and that of job 3, etc.) can be prevented, and the operator who executes the continuous test print processing can be prevented from being confused. In addition, the print processing of another job is inhibited during the continuous test print processing, while the control is made to permit to simultaneously execute the recording process of that job in the HDD 2004 parallel to the continuous test print operation. Hence, a time period until the print result of the other job can be shortened while providing the above effects, thus improving the productivity of the whole system. In this way, various needs of the operator can be flexibly met in consideration of the use environment of the operator. Note that such control is a function which is incorporated for the purpose of further improving the convenience and, hence, it is not always an indispensable constituent element.

In this embodiment, the CPU controls to allow the operator to confirm the print results of jobs to be continuously printed and to change settings of the printing conditions of the jobs to be continuously printed for each of the jobs to be continuously printed after he or she confirmed the print results, and controls the MFP 202 to execute the continuous print operations of the plurality of jobs immediately and/or at the date and time designated by the operator. Alternatively, the CPU may control to display preview images of jobs, which are processed based on the printing conditions of the jobs to be continuously printed, on a user interface unit comprising a preview function such as the display unit 501 of the MFP 202 or the like without any test print operations by the printer 2095 of the MFP 202, so as to allow the operator to confirm the print results for the plurality of jobs to be continuously printed, as long as the print results of the jobs to be continuously printed can be confirmed, and the operator can change the settings.

In such arrangement, the output process for allowing the operator to confirm the print results for the plurality of jobs to be continuously printed may be executed on both the printer and the display unit of the operation unit or on either one of these units.

In this manner, this system may be configured to execute the continuous test print processing of a plurality of jobs by the printer 2095 and/or continuous test display processing by the display unit 501 as the continuous test output processing of these jobs under the control of the CPU 2001.

This embodiment provides the specifications which are particularly suited to POD but does not always provide an apparatus and system suited to only such specific environment as well as embodiments to be described later. Of course, this embodiment provides an apparatus and system which are suited to operation environments other than POD such as an office environment and the like.

For example, this embodiment will explain a case wherein the operation unit 2012 of the MFP 202 executes the continuous operation control of a plurality of jobs including the above mode under the control of the CPU 2001. Also, this embodiment may adopt the following arrangement.

For example, the following system arrangement may be adopted. That is, a printer driver of an information processing apparatus such as the computer 201 or the like as an example of an external apparatus, which can make data communications with the MFP 202, may include the same multiple job continuous print function and multiple job continuous test print function as in the above mode. A CPU of the information processing apparatus may serve as a main controller, and may allow an operation unit of the computer to accept the selection process of a plurality of jobs to be continuously printed and a continuous print instruction of these jobs, a continuous test print instruction of these jobs and changes of settings of the printing conditions for each of these test-printed jobs, an instruction of the continuous test print operation of these jobs and a date-designated instruction after execution of a series of operations, and the like. In accordance with these instructions, the CPU may control the MFP 202 to execute the same control as in the above control.

Jobs to be processed may include job data (scanned image data) input from the scanner unit of the MFP 202 or that (PDL image data) output from the computer 201. Also, at least some of these plurality of types of job data may be processed.

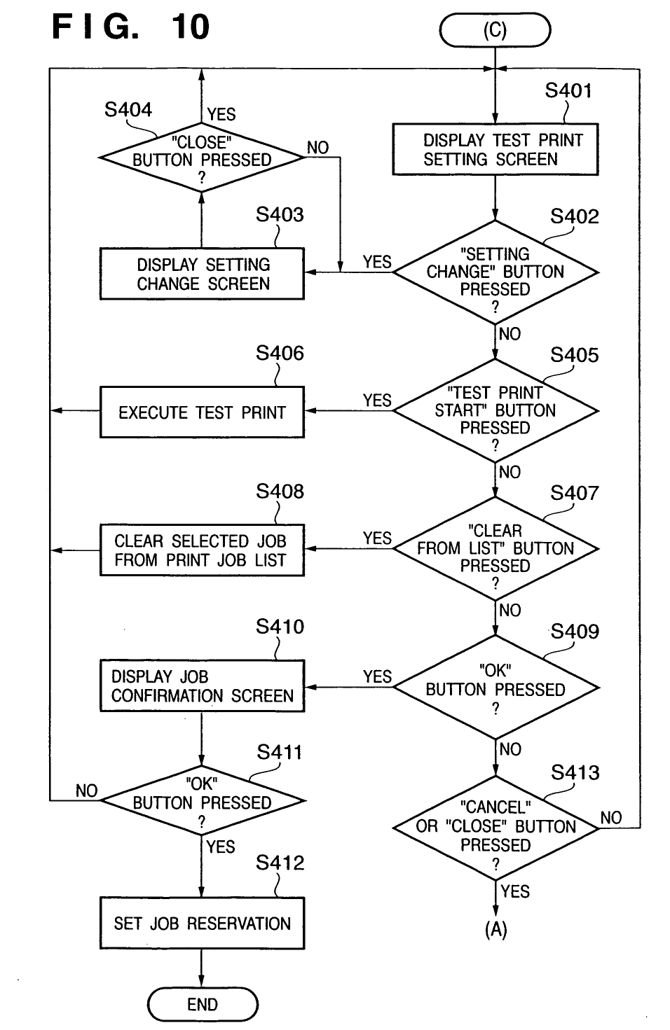

A description will revert to that in step S302 and subsequent steps of the flowchart in FIG. 8. If the operator presses the test print setting key 803 (YES in step S303), the MFP 202 checks if the time input to the time setting field 802 is valid. If the input time is valid (YES in step S304), the print start time is written in the printing condition information, and the flow advances to step S401 in FIG. 10. Also, a test print setting screen shown in FIG. 11 is displayed on the display unit 501. On the other hand, if the time input to the time setting field 802 is not valid (NO in step S304), a message “set date and time” is displayed on the display unit 501 (step S305), and the flow returns to step S301.

If a close key 804 is pressed (YES in step S306), the flow returns to step S202 to display the basic screen shown in FIG. 6.

(3. Print Setting)

The printing condition-settings and print job data reservation process in the “date-designated continuous print” mode will be described below. FIG. 10 is a flowchart showing the flow of processing for changing the printing condition settings, executing test print processing, and making a reservation for print job data.

In step S401, the test print setting screen shown in FIG. 11 is displayed on the display unit 501. If the operator presses the setting change key 1001 (YES in step S402), it is determined that print job data of interest is selected, and a setting change screen used to set the printing conditions of the print job data of interest is displayed (step S403).

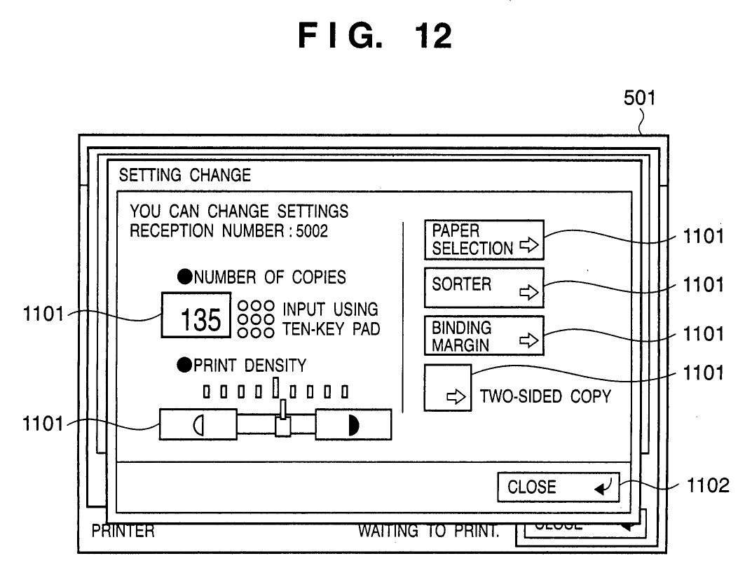

FIG. 12 shows an example of the setting change screen. An interface that allows the operator to make condition settings such as the number of copies to be printed and print density, paper selection, sorter, binding margin, two-sided copy, and the like by operating keys 1101 used to change the printing condition settings is displayed. Upon completion of the printing condition settings, if the operator presses a close key 1102 (YES in step S404), the printing condition information is corrected on the basis of the set printing conditions, and the flow returns to step S401 to display the test print setting screen shown in FIG. 11.

After the printing condition settings have been changed, if the operator selects print job data which is to be test-printed on a selected job list display area 1003 and presses a test print start key 1002 (YES in step S405), test print processing of the selected print job data starts (step S406), and the flow returns to step S401. At this time, the contents of the test print processing are as described above. According to the arrangement of this embodiment, the operator can repetitively change the printing condition settings and execute test print processing with reference to the test print result until he or she can obtain a desired print result.

If print job data which need not be printed is selected, i.e., if the operator selects print job data which need not be printed on the selected job list display area 1003 and presses a “clear from list” key 1004 (YES in step S407), the control is made to clear that print job data from the selected job list display area 1003 (step S408).

If the operator has made the printing condition settings of all the print job data displayed on the selected job list display area 1003 and presses an OK key 1005 (YES in step S409), the flow advances to step S410 to display a print job data confirmation screen.

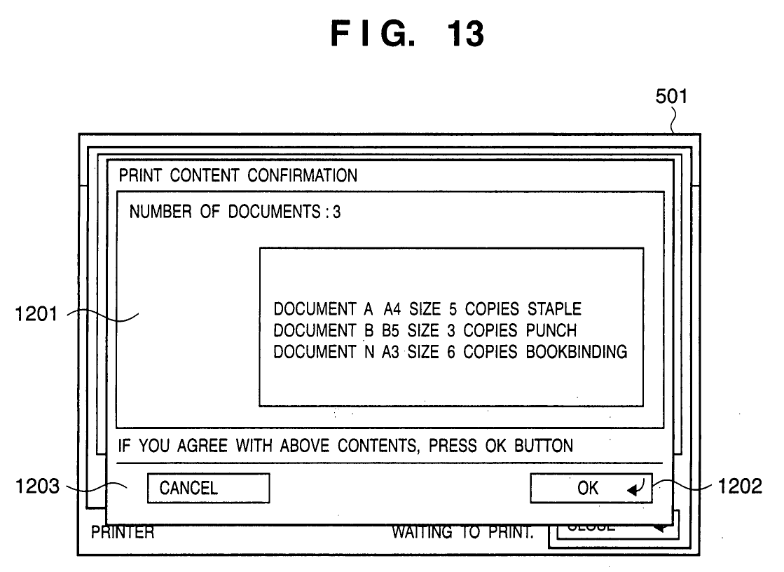

FIG. 13 shows an example of the print job data confirmation screen. A central area 1201 of the display unit 501 displays information such as the print start time, the number of documents, the printing conditions of these documents, and the like of print job data to be reserved. Note that these printing conditions are acquired with reference to the printing condition information.

If the operator presses an OK key 1202 on the print job data confirmation screen (YES in step S411), the flow advances to step S412 to reserve the print processing of these jobs. If the operator presses a cancel key 1203 (NO in step S411), the flow returns to step S401 to display the test print setting screen.

If the operator presses a cancel key 1006 or close key 1007 on the test print setting screen, the flow returns to step S202 to display the basic screen shown in FIG. 6.

As described above, in the “date-designated continuous print” mode of this embodiment, while a plurality of print job data are stored in the MFP 202, predetermined job data is selected and is test-printed, and the printing conditions are adjusted no the basis of the test print result. After that, if a desired print result is obtained, the print processing in large quantities can be reserved while maintaining the printing condition settings of the test print processing.

(4. Print Start)

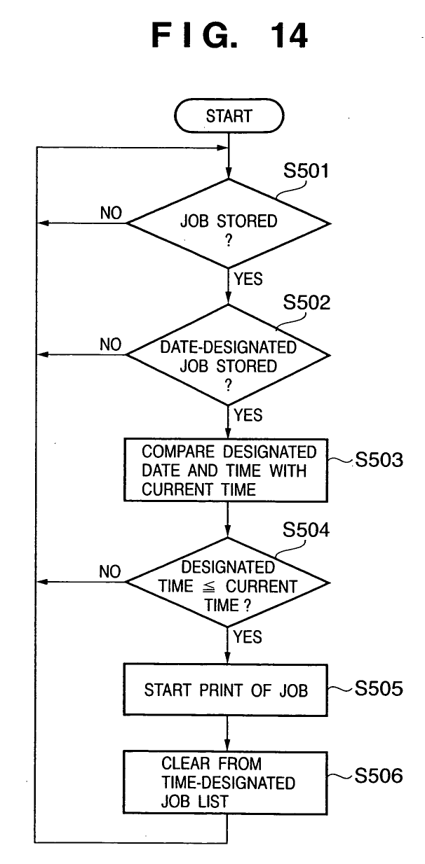

The print start processing in this embodiment will be described below. FIG. 14 is a flowchart showing the flow of print start processing in the MFP 202.

The MFP 202 checks in step S501 if print job data are input. If the print job data are input (YES in step S501), the flow advances to step S502; otherwise (NO in step S501), the flow returns to step S501 after the control waits for a predetermined period of time.

The MFP 202 checks in step S502 if the input print job data include those in the “date-designated continuous print” mode. If such jobs are included (YES in step S502), the flow advances to step S503; otherwise (NO in step S502), the flow returns to step S501 after the control waits for a predetermined period of time.

In step S503, the MFP 202 acquires the current time with reference to an internal clock (not shown). The MFP 202 then compares the designated date and time of the print job data with the current time. If the current time matches or elapses from the designated time of the print job data (YES in step S504), the flow advances to step S505 to start the print processing of the print job data. If the current time does not reach the designated time (NO in step S504), the flow returns to step S501 after the control waits for a predetermined period of time.

In step S505, image data of each print job data are recorded on printing media (printing sheets, OHP sheets, and the like) on the basis of the printing conditions of that print job data. Note that the print processing is done on the basis of all the conditions of the printing condition information associated with the print job data.

Upon completion of the print processing of the print job data, the print job data and corresponding printing condition information are deleted from the HDD 2004, and are cleared from the print job data list of the “date-designated continuous print” mode in step S506. The flow then returns to step S501.

With the above processing, the print processing of print job data can be started at the date and time designated by the operator.

<Processing in “Continuous Print” Mode>

The flow of processing in the “continuous print” mode will be described below. Note that the flow of the overall processing of the MFP 202 in the “continuous print” mode includes steps “1. print mode designation”, “2. selected print job data confirmation”, and “3. print setting/print”. The processes in the “2. selected print job data confirmation” step and the subsequent step will be explained.

(2. Selected Print Job Data Confirmation)

FIG. 15 is a flowchart showing the flow of processing for confirming selected print job data upon selection of the “continuous print” mode.

In step S601, a continuous print setting screen shown in FIG. 16 is displayed on the display unit 501. A list of print job data selected by the operator is displayed on a selected job list display area 1501 on the display unit 501. The operator can confirm if the print job data are correctly selected.

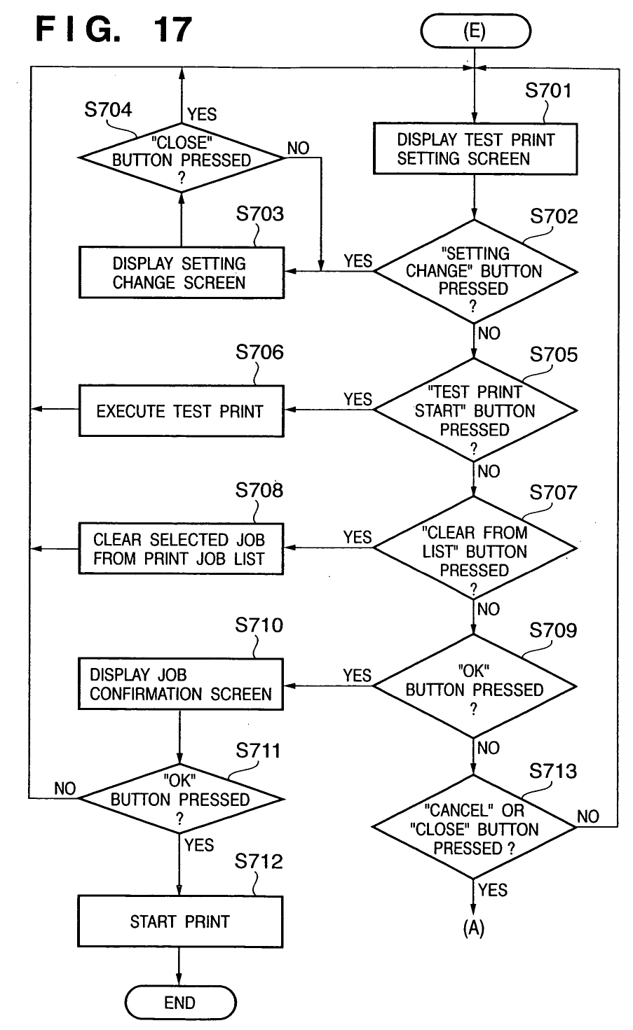

After the operator has confirmed that the print job data are correctly selected, he or she presses a test print setting key 1502 (YES in step S602). The MFP 202 displays a test print setting screen on the display unit 501 based on this event (step S701 in FIG. 17).

If the operator presses a close key 1503 (YES in step S603), the flow returns to step S202 to display the basic screen shown in FIG. 6.

(3. Print Setting/Print)

The printing condition settings and start operation of print processing in the “continuous print” mode will be described below. FIG. 17 is a flowchart showing the flow of processing for changing the printing condition settings, executing test print processing, and starting print processing.

In step S701, the test print setting screen shown in FIG. 11 is displayed on the display unit 501.

The “3. print setting/print” processing in the “continuous print” mode is substantially the same as the “3. print setting” in the “date-designated continuous print” mode. That is, the processes for changing the printing condition settings, executing test print processing, clearing job data from the job list, and canceling print processing are the same as those in the “3. print setting” in the “date-designated continuous print” mode. Unlike in the “date-designated continuous print” mode, upon depression of the OK key 1005, the print processing is immediately started after the print job data are confirmed in the “continuous print” mode.

The processes in steps S702 to S708 are the same as those in steps S402 to S408 of FIG. 10 which is referred to in the description of “3. print setting” in the “date-designated continuous print” mode. For this reason, as a description of the processes in steps S702 to S708, that of those in steps S402 to S408 will be quoted while reading S402 to S408 as S702 to S708.

After the printing condition settings of all the print job data displayed in the selected print job data list are complete, if the operator presses the OK key 1005 (YES in step S709), the flow advances to step S710 to display the print confirmation screen shown in FIG. 13. The central area 1201 of the display unit 501 displays information such as the number of documents, the printing conditions of these documents, and the like of print job data to be printed. Note that these printing conditions are acquired with reference to the printing condition information.

If the operator presses the OK key 1202 on the print confirmation screen (YES in step S711), the flow advances to step S712 to start print processing. Note that the print processing is done on the basis of all the conditions of the printing condition information associated with each print job data. If the operator presses the cancel key 1203 (NO in step S711), the flow returns to step S701 to display the test print setting screen.

If the operator presses the cancel key 1006 or close key 1007 on the test print setting screen, the flow returns to step S202 to display the basic screen shown in FIG. 6.

As described above, in the “continuous print” mode of this embodiment, while a plurality of print job data are stored in the MFP 202, predetermined print job data are selected and test-printed, and the printing conditions are adjusted based on the test print results. When desired print results are obtained, the print processing in large quantities can be reserved while maintaining the printing condition settings of the test print processing.

### Other Embodiments

The embodiment described so far relates to the arrangement in which print job data is transmitted from an information processing apparatus to an image forming apparatus, which performs test print processing, printing condition settings, and print or reserved print processing. However, the present invention is not limited to such specific arrangement. That is, the present invention also includes an arrangement in which image data scanned by the scanner 2071, PDL image data sent from the information processing apparatus, received FAX document data, and the like are saved in advance in boxes of the HDD 2004, and the test print processing, printing condition settings, and print or reserved print processing are performed by the image forming apparatus later.

In this embodiment, the MFP has been exemplified as the image forming apparatus, but the present invention is not limited to such specific apparatus. That is, the present invention can be applied when a printer such as an LBP, ink-jet printer, or the like is used as the image forming apparatus.

The preferred embodiments of the present invention have been explained, and the present invention can be practiced in the forms of a system, apparatus, method, program, storage medium, and the like. Also, the present invention can be applied to either a system constituted by a plurality of devices, or an apparatus consisting of a single equipment.

Note that the present invention includes a case wherein the invention is achieved by directly or remotely supplying a program of software (a program corresponding to each illustrated flowcharts in the above embodiments) that implements the functions of the aforementioned embodiments to a system or apparatus, and reading out and executing the supplied program code by a computer of that system or apparatus.

Therefore, the program code itself installed in a computer to implement the functional process of the present invention using the computer implements the present invention. That is, the scope of the claims of the present invention includes the computer program itself for implementing the functional process of the present invention.

In this case, the form of program is not particularly limited, and an object code, a program to be executed by an interpreter, script data to be supplied to an OS, and the like may be used as along as they have the program function.

As a recording medium for supplying the program, for example, a floppy® disk, hard disk, optical disk, magnetooptical disk, MO, CD-ROM, CD-R, CD-RW, magnetic tape, nonvolatile memory card, ROM, DVD (DVD-ROM, DVD-R), and the like may be used.

As another program supply method, the program may be supplied by establishing connection to a home page on the Internet using a browser on a client computer, and downloading the computer program itself of the present invention or a compressed file containing an automatic installation function from the home page onto a recording medium such as a hard disk or the like. Also, the program code that forms the program of the present invention may be segmented into a plurality of files, which may be downloaded from different home pages. That is, the present invention includes a WWW server which makes a plurality of users download a program file required to implement the functional process of the present invention by the computer.

Also, a storage medium such as a CD-ROM or the like, which stores the encrypted program of the present invention, may be delivered to the user, the user who has cleared a predetermined condition may be allowed to download key information that decrypts the program from a home page via the Internet, and the encrypted program may be executed using that key information to be installed on a computer, thus implementing the present invention.

The functions of the aforementioned embodiments may be implemented not only by executing the readout program code by the computer but also by some or all of actual processing operations executed by an OS or the like running on the computer on the basis of an instruction of that program.

Furthermore, the functions of the aforementioned embodiments may be implemented by some or all of actual processes executed by a CPU or the like arranged in a function extension board or a function extension unit, which is inserted in or connected to the computer, after the program read out from the recording medium is written in a memory of the extension board or unit.

As described above, according to the present invention, an image forming apparatus, job processing method, and the like, which consider the needs, operability, and use environments of the operator in the print system, can be provided.

As many apparently widely different embodiments of the present invention can be made without departing from the spirit and scope thereof, it is to be understood that the invention is not limited to the specific embodiments thereof except as defined in the claims.

### CLAIM OF PRIORITY

This application claims priority from Japanese Patent Application No. 2004-257419 filed on Sep. 3, 2004, which is hereby incorporated by reference herein.

What is claimed is:

1. An image forming apparatus which can print job data in storage unit that can store a plurality of independent job data, comprising:
control unit adapted to control said image forming apparatus to execute a multiple job continuous print operation for continuously executing print processing of a plurality of independent job data of the job data in the storage unit, and
in that said control unit controls said image forming apparatus to execute test print processing of each of the plurality of job data to be continuously printed to allow a user to confirm a print result before completion of all print processes of the plurality of job data to be continuously printed by the multiple job continuous print operation.

2. An image forming apparatus which can print job data in storage unit that can store a plurality of independent job data, comprising:
control unit adapted to control said image forming apparatus to execute a multiple job continuous print operation for continuously executing print processing of a plurality of independent job data of the job data in the storage unit under printing conditions which are already set for each job, and
in that said control unit controls said image forming apparatus to execute test print processing of each of the plurality of job data to be continuously printed to allow a user to confirm a print result before completion of all print processes of the plurality of job data to be continuously printed by the multiple job continuous print operation,
said control unit allows to change the printing conditions of the plurality of job data to be continuously printed after completion of the test print processing, and
said control unit controls said image forming apparatus to execute the multiple job continuous print operation of the plurality of job data after the printing conditions have been changed.

3. The apparatus according to claim 1, wherein said control unit controls said image forming apparatus to execute the multiple job continuous print operation in one mode designated by the user of:
an immediate continuous print mode that controls to execute the multiple job continuous print operation at a selection timing of jobs to be continuously printed by the user; and
a date-designated continuous print mode that controls to execute the multiple job continuous print operation at a timing designated by the user in place of the selection timing of the jobs to be continuously printed by the user.

4. An image forming apparatus having printer unit which can print job data in storage unit which can store a plurality of independent job data including first and second job data, comprising:
control unit adapted to control the printer unit to execute a first continuous operation that executes print processing of the first job data in the storage unit, and executes print processing of the second job data, on the basis of a first instruction, and
in that said control unit controls the printer unit and/or an operation unit to execute a second continuous operation that executes test output processing that allows a user to confirm a print result of the first job data in the storage unit, and executes test output processing that allows a user to confirm a print result of the second job data in the storage unit, on the basis of a second instruction, and
said control unit can complete the second continuous operation based on the second instruction before the beginning of the first continuous operation based on the first instruction.

5. An image forming apparatus having printer unit which can print job data in storage unit which can store a plurality of independent job data including first and second job data, comprising:
control unit adapted to control the printer unit to execute a first continuous operation that executes print processing of the first job data in the storage unit, and executes print processing of the second job data, and
in that said control unit controls the printer unit and/or an operation unit to execute a second continuous operation that executes test output processing that allows a user to confirm a print result of the first job data in the storage unit, and executes test output processing that allows a user to confirm a print result of the second job data in the storage unit, and
said control unit can inhibit print processing of another print job by the printer unit during execution of the second continuous operation by the printer unit and/or the operation unit.

6. An image forming apparatus having printer unit which can print job data in storage unit which can store a plurality of independent job data including first and second job data, comprising:
control unit adapted to control the printer unit to execute a first continuous operation that executes print processing of the first job data in the storage unit, and executes print processing of the second job data, and
in that said control unit controls the printer unit and/or an operation unit to execute a second continuous operation that executes test output processing that allows a user to confirm a print result of the first job data in the storage unit, and executes test output processing that allows a user to confirm a print result of the second job data in the storage unit, and
when said control unit executes the first continuous operation in a first order in which the print processing of the second job data is executed after the print processing of the first job data is executed, said control unit allows to execute the second continuous operation in the same order as the first order in which the test output processing that allows the user to confirm the print result of the second job data is executed after the test output processing that allows the user to confirm the print result of the first job data is executed, and when said control unit executes the first continuous operation in a second order in which the print processing of the first job data is executed after the print processing of the second job data is executed, said control unit allows to execute the second continuous operation in the same order as the second order in which the test output processing that allows the user to confirm the print result of the first job data is executed after the test output processing that allows the user to confirm the print result of the second job data is executed.

7. The apparatus according to claim 4, wherein the user is allowed to select one of a first mode that executes the first continuous operation of the first and second continuous operations at a timing designated by the user, and a second mode that executes the first continuous operation at a timing other than the designated timing.

8. A job processing method of an image forming apparatus which can print job data in storage unit that can store a plurality of independent job data, comprising steps of:
controlling the image forming apparatus to execute a multiple job continuous print operation for continuously executing print processing of a plurality of independent job data of the job data in the storage unit; and
controlling the image forming apparatus to execute test print processing of each of the plurality of job data to be continuously printed to allow a user to confirm a print result before completion of all print processes of the plurality of job data to be continuously printed by the multiple job continuous print operation.

9. A job processing method of an image forming apparatus which can print job data in storage unit that can store a plurality of independent job data, comprising steps of:
controlling the image forming apparatus to execute a multiple job continuous print operation for continuously executing print processing of a plurality of independent job data of the job data in the storage unit under printing conditions which are already set for each job;
controlling the image forming apparatus to execute test print processing of each of the plurality of job data to be continuously printed to allow a user to confirm a print result before completion of all print processes of the plurality of job data to be continuously printed by the multiple job continuous print operation;
allowing to change the printing conditions of the plurality of job data to be continuously printed after completion of the test print processing; and
controlling the image forming apparatus to execute the multiple job continuous print operation of the plurality of job data after the printing conditions have been changed.

10. The method according to claim 8, further comprising a step of controlling the image forming apparatus to execute the multiple job continuous print operation in one mode designated by the user of:
an immediate continuous print mode that controls to execute the multiple job continuous print operation at a selection timing of jobs to be continuously printed by the user; and
a date-designated continuous print mode that controls to execute the multiple job continuous print operation at a timing designated by the user in place of the selection timing of the jobs to be continuously printed by the user.

11. A job processing method of an image forming system including an image forming apparatus having printer unit which can print job data in storage unit which can store a plurality of independent job data including first and second job data, comprising steps of:
controlling the printer unit to execute a first continuous operation that executes print processing of the first job data in the storage unit, and executes print processing of the second job data, on the basis of a first instruction;
controlling the printer unit and/or an operation unit to execute a second continuous operation that executes test output processing that allows a user to confirm a print result of the first job data in the storage unit, and executes test output processing that allows a user to confirm a print result of the second job data in the storage unit, on the basis of a second instruction; and
allowing to complete the second continuous operation based on the second instruction before the beginning of the first continuous operation based on the first instruction.

12. A job processing method of an image forming system including an image forming apparatus having printer unit which can print job data in storage unit which can store a plurality of independent job data including first and second job data, comprising steps of:
controlling the printer unit to execute a first continuous operation that executes print processing of the first job data in the storage unit, and executes print processing of the second job data;
controlling the printer unit and/or an operation unit to execute a second continuous operation that executes test output processing that allows a user to confirm a print result of the first job data in the storage unit, and executes test output processing that allows a user to confirm a print result of the second job data in the storage unit; and
inhibiting print processing of another print job by the printer unit during execution of the second continuous operation by the printer unit and/or the operation unit.

13. A job processing method of an image forming system including an image forming apparatus having printer unit which can print job data in storage unit which can store a plurality of independent job data including first and second job data, comprising steps of:
controlling the printer unit to execute a first continuous operation that executes print processing of the first job data in the storage unit, and executes print processing of the second job data;
controlling the printer unit and/or an operation unit to execute a second continuous operation that executes test output processing that allows a user to confirm a print result of the first job data in the storage unit, and executes test output processing that allows a user to confirm a print result of the second job data in the storage unit; and
allowing to execute, when the first continuous operation is executed in a first order in which the print processing of the second job data is executed after the print processing of the first job data is executed, the second continuous operation in the same order as the first order in which the test output processing that allows the user to confirm the print result of the second job data is executed after the test output processing that allows the user to confirm the print result of the first job data is executed, and allowing to execute, when the first continuous operation is executed in a second order in which the print processing of the first job data is executed after the print processing of the second job data is executed, the second continuous operation in the same order as the second order in which the test output processing that allows the user to confirm the print result of the first job data is executed after the test output processing that allows the user to confirm the print result of the second job data is executed.

14. The method according to claim 11, further comprising a step of allowing the user to select one of a first mode that executes the first continuous operation of the first and second continuous operations at a timing designated by the user, and a second mode that executes the first continuous operation at a timing other than the designated timing.

15. The method according to claim 11, further comprising a step of allowing to execute test print processing by the printer unit and/or preview display processing of the print result as the test output processing in the second continuous operation.

16. The method according to claim 11, wherein the plurality of job data include at least some of job data from scanner unit of the image forming apparatus and job data output from an information processing apparatus which can make a data communication with the image forming apparatus, and the operation unit includes an operation unit of the image forming apparatus.

17. The method according to claim 11, wherein the plurality of job data include at least some of job data from scanner unit of the image forming apparatus and job data output from an information processing apparatus which can make a data communication with the image forming apparatus, and the operation unit includes an operation unit of the information processing apparatus.

18. The method according to claim 11, further comprising a step of allowing the user to change settings of printing conditions of the first and second job data to be processed in the first continuous operation for each job via the operation unit after the test output processing in the second continuous operation.

19. The method according to claim 8, wherein the plurality of job data include job data from scanner unit of the image forming apparatus and/or job data output from an information processing apparatus which can make a data communication with the image forming apparatus.

20. An image forming system for executing a job processing method of claim 8.

21. A computer-readable storage medium for storing a computer program for implementing a job processing method of claim 8.

22. A computer program for implementing a job processing method of claim 8.
